(19) United States
(12) Patent Application Publication
(10) Pub. No.: US 2013/0122763 A1
(43) Pub. Date: May 16, 2013

(54) COMPOSITE MATERIALS

(71) Applicants: Christopher N. Fish, Central Point, OR (US); Frank L. Ghiono, Reno, NV (US)

(72) Inventors: Christopher N. Fish, Central Point, OR (US); Frank L. Ghiono, Reno, NV (US)

(73) Assignee: Composite Tech, LLC.

(21) Appl. No.: 12/574,089

(22) Filed: Oct. 6, 2009

(51) Int. Cl. B32B 27/04; B32B 5/02; B05D 3/06; B05D 3/02

(52) U.S. Cl. 442/59; 427/385.5; 427/387; 428/297.4; 427/487

(57) ABSTRACT

Fiber reinforced thermoset plastic composites with a glass transition temperature of greater than 500° C. are disclosed. Certain embodiments of the disclosed fiber reinforced thermoset plastic composites are produced using pre-ceramic resin and fibers that are stable under thermal stress. Also disclosed are methods of making these fiber reinforced thermoset plastic composites. These methods include infiltrating thermally stable fibrous material with a pre-ceramic resin and introducing crosslinking. The disclosed methods produce a non-ceramic highly crosslinked thermoset plastic composite that possesses both thermal stability and mechanical strength.

### CROSS REFERENCE TO RELATED APPLICATION

This application claims the benefit of the earlier filing date of International Application Number PCT/US2008/063271, filed on May 9, 2008 and U.S. Provisional Patent Application No. 60/928,746, filed on May 10, 2007, both of which applications are incorporated herein by reference.

### FIELD

The present disclosure relates to fiber reinforced thermoset plastic composites having high temperature stability. This disclosure also relates to methods for making fiber reinforced thermoset plastic composites having high temperature stability.

### BACKGROUND

Fiber reinforced thermoset plastic composites enjoy widespread use in diverse applications such as in the construction of aircraft, automobiles, and water craft. Fiber reinforced thermoset plastic composites are typically characterized as materials containing reinforcing fibers embedded in a thermosetting polymer and are generally valued for their high strength-to-weight ratio. In common applications, the reinforcing fiber is typically fiberglass, although in advanced applications other reinforcements have be used, including high strength and/or fire resistant fibers, such as aramid (for example, NOMEX® and KEVLAR®), graphite, and carbon among others.

Thermosetting polymers are typically supplied as liquids or partially polymerized solid molding powders that react during processing to form crosslinked structures that typically cannot be re-melted and/or reprocessed. In their uncrosslinked condition, they can be formed to the finished product shape with or without pressure and crosslinked by various methods including chemical crosslinking and/or crosslinking induced by exposure to an energy source, such as electromagnetic radiation and/or heat.

In the last three decades, many in the building, aerospace, marine and transportation industries, and those in fire prevention and insurance businesses, have recognized that many non-metallic products (such as conventional thermoset polymer composites) pose serious fire, toxicity, and thermal stability problems. Aerospace grade epoxies, commonly used for commercial aerospace applications, even encounter serious thermal limitations at continuous operating temperatures of about 250° C. and above. This often necessitates the need for additional thermal barrier protection in lieu of the unavailability of thermoset polymer composites with greater thermal stability and desirable mechanical characteristics. New generations of organic polymeric materials, such as benzoxazines, BMI, cyanate esters, PEEK™, phthalonitriles and polyimides developed for moderately high temperature applications. However, these polymers have some associated processing difficulties, high use costs, and practical service limitations of only being able to withstand temperatures up to about 300° C. to 350° C. While the convenience of fabrication often outweighs their disadvantages, the limitations of traditional fiber reinforced thermoset polymer composites have fostered the development of metal-matrix, carbon-carbon and, more recently, ceramic-matrix composites.

Ceramic matrix materials are valued for their mechanical stability at high-temperature, and they are an obvious choice for applications where a material will be exposed to elevated temperatures for any length of time, for example as a component in a jet engine. In some examples, ceramic materials have the ability to withstand extreme temperatures, such as temperatures exceeding 1,600° C.

Incorporation of continuous fibers into a ceramic matrix has yielded ceramic composite materials with superior properties by providing a toughening mechanism that lessens the propensity for catastrophic failure. Examples of ceramic composites and methods of producing such composites can be found, for example, in U.S. Pat. Nos. 4,668,642; 5,494,867; 5,856,252; 6,331,496; 6,342,269; 6,743,393; and U.S. Patent Application Publication Nos. 2001/0008865 and 2002/0190409.

Unlike metals, which are somewhat compliant, ceramic particles are very hard and abrasive and the fibers that are utilized to reinforce such composites often are broken during processing. Fiber breakage is detrimental to the integrity of the final composite and can, in some instances, result in a composite exhibiting mechanical properties inferior to the unreinforced ceramic. A characteristic of ceramic materials is that they typically require a high temperature pyrolysis step during manufacture, such as pyrolysis at a temperature greater than 1,000° C., and thus necessitate the use of costly ovens or kilns. Pyrolysis often results in products that contain voids or other defects such as shrinkage, which may require expensive post fabrication tooling. In addition, the ceramic yields are typically very low and the resulting articles require a large number of infiltration cycles to obtain a part with acceptable porosity levels.

The ceramic composites obtained from these methods exhibit some desirable properties, such as mechanical stability at extreme temperature. However, while ceramics composites have enormous potential, their adoption has been seriously hampered by their brittle fracture behavior, high flaw sensitivity, low tensile strength and/or high cost of production. As a result, thermoset polymeric composites are generally preferred in applications wherein additional protective measures can be taken to keep the composites from thermal degradation.

### SUMMARY

Based on the above discussion, it will be apparent that need exists for a material that combines the high strength-to-weight ratio of a thermoset plastic composite with the heat resistance of a ceramic composite. The present disclosure solves this need by providing fiber reinforced thermoset plastic composites with high mechanical strength that are capable of maintaining integrity under thermal stress.

The present disclosure relates to a new class of fiber reinforced thermoset plastic composites with high glass transition temperatures. Accordingly, fiber reinforced thermoset plastic composites with exceptional thermal tolerance are disclosed. Also disclosed are methods of making such composites. The disclosed fiber reinforced thermoset plastic composites are based on the discovery that pre-ceramic resins can be effectively crosslinked to produce a rigid composite material. The crosslinking of the pre-ceramic resin results in a highly crosslinked non-ceramic material with a glass transition temperature of greater than about 500° C.

The disclosed the fiber reinforced thermoset plastic composites include a fiber material infiltrated with a crosslinkable thermosetting pre-ceramic resin. In some examples, crosslinkable thermosetting pre-ceramic resin contains polysilazane based polymer, a polycarbosilane based polymer, or a combination thereof. Thermosetting pre-ceramic resins useful for producing the disclosed composites are generally viscous, with a viscosity greater than about 20 centipoise (cps) at 25° C. However, both lower and higher viscosity resins have produced useful articles. Thermosetting polymers used in the disclosed composite materials typically crosslink at a temperature between about 0 and about 300° C.

Typically, the disclosed composites include reinforcing fibers that are thermostable, meaning that they maintain structural integrity at an elevated temperature, such as temperatures in excess of about 350° C., such as greater than about 400° C. Examples of suitable fiber materials include, without limitation, metal, glass, ceramic, pre-ceramic polymer, ceramic from ceramic precursors, polymer, carbon, mineral, quartz fibers or blends thereof.

Methods of making fiber reinforced thermoset plastic composites are also disclosed. These methods involve infiltrating a fiber material with a polymeric pre-ceramic resin with a viscosity greater than about 20 centipoise (cps) at 25° C., and introducing crosslinks into the polymeric pre-ceramic resin, thereby making a fiber reinforced thermoset plastic composite. Crosslinking can take place at a pressure of from about 0.1 to about 10 bar in air or a defined atmosphere and generally occurs in about 30 minutes to about 20 hours.

The foregoing and other objects, features, and advantages of the invention will become more apparent from the following detailed description, which proceeds with reference to the accompanying figures.

### BRIEF DESCRIPTION OF THE DRAWINGS

FIG. 1A is a diagram of an exemplary fiber reinforced composite material formed from short fibers embedded in crosslinked pre-ceramic resin.

FIG. 1B is a diagram of an exemplary fiber reinforced composite material formed from long uniaxial fibers embedded in crosslinked pre-ceramic resin.

FIG. 1C is a diagram of an exemplary fiber reinforced composite material formed from a bidirectional fabric embedded in crosslinked pre-ceramic resin.

FIG. 1D is a diagram of an exemplary fiber reinforced composite material formed from several layers of laminated long uniaxial fibers embedded in crosslinked pre-ceramic resin.

FIG. 2 is an exploded diagram showing the various components that make up an exemplary jet engine nacelle.

FIG. 3A is a drawing of an exemplary biaxial woven fabric.

FIG. 3B is a drawing of an exemplary triaxial woven fabric.

FIG. 3C is a drawing of an exemplary knit fabric.

FIG. 3D is a drawing of an exemplary multiaxial multilayer warp knit fabric.

FIG. 3E is a drawing of an exemplary three-dimensional woven preform.

FIG. 3F is a drawing of an exemplary three-dimensional braided preform.

FIG. 3G is a drawing of an exemplary three-dimensional orthogonal woven fabric.

FIG. 3H is a drawing of an exemplary three-dimensional woven fabric of angle interlock construction.

FIG. 4A is a drawing of a plain weave fabric in which each warp fiber passes alternately under and over each weft fiber.

FIG. 4B is a drawing of a twill weave fabric in which one or more warp fibers alternately weave over and under two or more weft fibers in a regular repeated manner.

FIG. 4C is a drawing of a satin weave fabric in which a twill weave is modified to produce fewer intersections of warp and weft.

FIG. 4D is a drawing of a basket weave fabric in which a plain weave is modified so that two or more warp fibers alternately interlace with two or more well fibers.

FIG. 4E is an illustration of a leno weave fabric.

FIG. 4F is an illustration of a mock leno weave fabric.

FIG. 5 is a schematic drawing of an exemplary resin transfer apparatus.

FIG. 6 is a schematic drawing of an exemplary vacuum assisted resin transfer apparatus.

FIG. 7 is a schematic drawing of an exemplary filament winding apparatus.

FIG. 8 is a schematic drawing of an exemplary pultrusion apparatus.

### DETAILED DESCRIPTION

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. The term “comprises” means “includes.” Hence “comprising A or B” means including A, B, or A and B. Although methods and materials similar or equivalent to those described herein can be used in the practice or testing of this disclosure, suitable methods and materials are described below. The materials, methods, and examples described herein are merely illustrative and not intended to be limiting.

The present disclosure relates to fiber reinforced thermoset plastic composites that exhibit high strength-to-weight ratios and high mechanical stabilities under thermal stress. Accordingly, disclosed herein is a new class of fiber reinforced thermoset plastic composites that overcome both the thermal stability problems associated with traditional composites and the mechanical limitations of ceramic composite materials. Also disclosed are methods for making this new class of fiber reinforced thermoset plastic composites. Certain disclosed embodiments concern fiber reinforced thermoset plastic composites where pre-ceramic resins can be effectively and efficiently crosslinked in the presence of thermally stable fibers to form fiber reinforced thermoset plastic composites that exceed both the mechanical strength of ceramics and the thermal stability of traditional composite materials. The disclosed fiber reinforced thermoset plastic composites are produced using pre-ceramic resins which can be crosslinked without the need for costly and inefficient pyrolysis steps.

The fiber reinforced thermoset plastic composites disclosed herein are useful for making articles that are flexible, resistant to cracking and embrittlement. Certain embodiments of the disclosed composites demonstrate high resistance to flame spread and favorable heat release. The disclosed fiber reinforced thermoset plastic composites retain the mechanical strength of traditional fiber reinforced composites (such as glass or carbon fiber reinforced composites) and can be produced at a competitive production cost. In addition, the disclosed fiber reinforced thermoset plastic composites have superior thermal stability properties, exhibiting thermal and mechanical stability greater than about 300° C., compared to glass or carbon fiber reinforced composites, whose thermal stability usually drops at about 250° C. In certain embodiments, the disclosed fiber reinforced thermoset plastic composites are non-combustible, do not evolve any fumes, and do not melt. Such composites are markedly superior to current flammable composite materials.

Embodiments of the disclosed fiber reinforced thermoset plastic composites do not achieve the thermal properties of ceramic composites, but are much simpler and less expensive to produce. Particular disclosed embodiments of fiber reinforced thermoset plastic composites are distinguished from ceramic composites in that the pre-ceramic resins are not converted into a ceramic. Rather, the pre-ceramic resin is in the form of a highly crosslinked polymer that can be thermoset without pyrolysis and the associated limitations inherent in pyrolysis. The resulting fiber reinforced thermoset plastic composite exhibits surprisingly excellent thermal and mechanical properties. Compared to ceramic composites, the disclosed composites are produced by simple production processes at low reaction temperatures and result in shorter production times and the associated costs.

A. Fiber Reinforced Composites

Aspects of this disclosure relate to fiber reinforced thermoset plastic composites. The disclosed fiber reinforced thermoset plastic composites are produced from fiber reinforcing material that has been infiltrated with a polymeric crosslinkable pre-ceramic resin. Examples of polymeric crosslinkable pre-ceramic resins that can be used in the formation of the disclosed fiber reinforced thermoset plastic composites include, without limitation, pre-ceramic resins typically used for the formation of fiber reinforced ceramics made up of silicon carbide, silicon nitride, silicon oxycarbide, and silicon oxynitride among others. The polymeric thermosetting pre-ceramic resins suitable for use making the disclosed fiber reinforced thermoset plastic composites are developed from one of a number of polymeric pre-ceramic resins, including and not limited to, polysilazanes such as perhydropolysilazanes, methylhydridocyclosilazanes, alkylhydridocyclosilazanes, and polyureidosilazanes, polysiloxanes, polyalkylsilsesquioxanes, such as polymethylsilsesquioxanes, polyvinylsilsequioxanes, polyphosphazines, polyborosilanes, polycarbosilazanes, methylpolycarbosilane, vinylpolycarbosilanes, methylvinylpolycarbosilane, polytitanocarbosilane, allyl hydridopolycarbosilanes, hydridopolycarbosilane, ureamethylvinylsilazanes, polyvinylsiloxanes, polymethylsiloxanes, polycarbosilanes, variants, derivatives and combinations thereof. A description of specific examples of pre-ceramic resins that can be used in the disclosed fiber reinforced thermoset plastic composites and in methods of making such composites can be found in section B below. In one embodiment, co-curing and/or blending of these subject pre-ceramic polymers with other state of the art polymers yield composites structures with higher thermal tolerance. Pre-ceramic thermosetting resins useful in the disclosed methods and for producing the disclosed fiber reinforced thermoset plastic composites are typically obtained (for example manufactured or purchased) in a liquid form with a low to moderate viscosity, for example in the range of from about 10 to about 200 centipoise (cps). The disclosed pre-ceramic thermosetting resins are typically manufactured using ammonolysis, are generally hydrolytically sensitive and will generate a mild to strong ammonia or ammonia-like odor upon contact with moisture. These pre-ceramic thermosetting resins are available up to about 99% purity and are generally soluble in common organic solvents, such as hexane, toluene or tetrohydrofuran (THF), and insoluble in water. The pre-ceramic thermosetting resins are typically modified as described herein to produce a modified resin with a suitable viscosity for standard composite manufacturing applications. The viscosity of the resulting resin is adjusted for the specific application, for example the type of lay-up. In some embodiments, the modified thermoset resin has a viscosity greater than about 20 cps, at about 25° C., such as greater than about 20 cps, greater than about 50 cps, greater than about 100 cps, greater than about 200 cps, greater than about 300 cps, greater than about 400 cps, or even greater than about 450 cps at about 25° C. However, some useful fiber reinforced thermoset plastic composite articles have been made from pre-ceramic resins which were extremely viscous so as to not be generally considered as liquids. In addition, some useful fiber reinforced thermoset plastic composite articles have been made from pre-ceramic resins which were of low viscosity, such that the crosslinking process was stepped and/or prolonged to achieve the desired results.

The reinforcing fibers for use in the disclosed composites and methods of making such composites are typically made from metal, glass, ceramic (such as those made from pre ceramic resins such as polysilazane and/or polycarbosilane and variants or derivatives thereof), carbon, quartz, basalt, or mineral fibers. Examples of fiber reinforcement materials and compositions suitable for use in the disclosed fiber reinforced thermoset plastic composites and methods of making such composites can be found in section C below.

It is understood by those of ordinary skill in art that the crosslinking of the desired composite can be a function of time and temperature and pressure and, to some degree, humidity. Thus crosslinking, under the right conditions, could take place at or below room temperature (such as <22° C.), at low elevated temperatures (such as <150° C.), at low to moderate elevated temperatures (such as <300° C.), or at higher temperatures. However, it is well understood to those of ordinary skill in the art that the crosslinking time and/or pressures can be dependent on various factors such as the type of resin and the polymerization initiated amongst others. Generally, the lowest crosslinking temperature that is sufficient to initiate crosslinking is used to lower tooling and processing/fabrication costs. In addition, higher crosslinking temperatures may cause the gas evolution, which may in turn impart excessive porosity into the resulting composite.

Once infused with pre-ceramic precursor resin, the infiltrated reinforcing matrix is cured by crosslinking the pre-ceramic resin at a temperature that is typically from room temperature to an elevated temperature, such as from about 20 to about 350° C. Crosslinking can occur in about 0.1 to about 20 hours in air or under a defined atmosphere such as an inert and/or protective gas. The crosslinking can be carried out at a pressure of about 0.1 bar to about 10 bar. The infiltration and crosslinking operation can be linear or stepped and may consist of one cycle or multiple cycles. It has been found that a linear crosslinking operation of one cycle is generally sufficient.

The fiber reinforced thermoset plastic composites of this disclosure typically have a glass transition at a temperature greater than about 350° C., such as greater than about 400° C. and in certain embodiments greater than about 550° C., such as greater than about 600° C., greater than about 650° C. or even greater than about 700° C. The glass transition temperature (Tg) is the temperature or, more accurately, the range of temperatures, where a thermoset material transitions from being rigid and glass-like below the Tg toward becoming “rubbery” and more compliant above the Tg. Glass transition temperature can be measured by a variety of techniques well known to those of ordinary skill in the art, for example differential scanning calorimetry (DSC), thermal-mechanical analysis (TMA), or dynamic-mechanical analysis (DMA).

The fiber reinforced thermoset plastic composites of this disclosure typically have a tensile strength greater than about 30,000 pounds per square inch (psi) at 25° C., such as greater than about 40,000 pounds per square inch, greater than about 60,000 pounds per square inch, or even greater than about 60,000 pounds per square inch. The disclosed fiber reinforced composites also resist fracture at a pressure stress of greater than about 10,000 bar at 23° C., such as greater than about 15,000 bar, or even greater than about 20,000 bar. At elevated temperatures, such as about 450° C., this structural integrity is maintained. For example certain disclosed embodiments of the disclosed fiber reinforced thermoset plastic composites resist fracture at a pressure stress greater than about 5,000 bar at 450° C., such as greater than about 6,000 bar greater than about 7,000 bar greater than about 8,000 bar greater than about 9,000 bar, or even greater than about 10,000 bar. Methods of measuring the physical stresses that a material (such as the disclosed fiber reinforced thermoset plastic composites) can tolerate are well known in the art and can be found for example, in American Society for Testing and Materials (ASTM) “Annual Book of ASTM Standards” published by ASTM International, West Conshohocken, Pa., USA.

The fiber reinforced thermoset plastic composites can be formed into a shaped article prior to crosslinking using a form, a mold, a mandrill or another suitable technique that gives shape to the final article produced. Shaped articles can be finished articles, that is they require no further modification. Alternatively, shaped articles can be further modified, for example by additional tooling, such as machining, shaping, grinding and the like.

The shaped articles can be used for any application where the properties (such as thermal and mechanical stability) of the disclosed fiber reinforced thermoset plastic composite are desirable. Without limitation, shaped articles can be used in an element of an aircraft, for example in a jet engine such as a portion of a nacelle; an element of a spacecraft, for example in a component that undergoes thermal and mechanical stress during planetary atmospheric entry; or an element of a motor vehicle engine, for example an exhaust manifold.

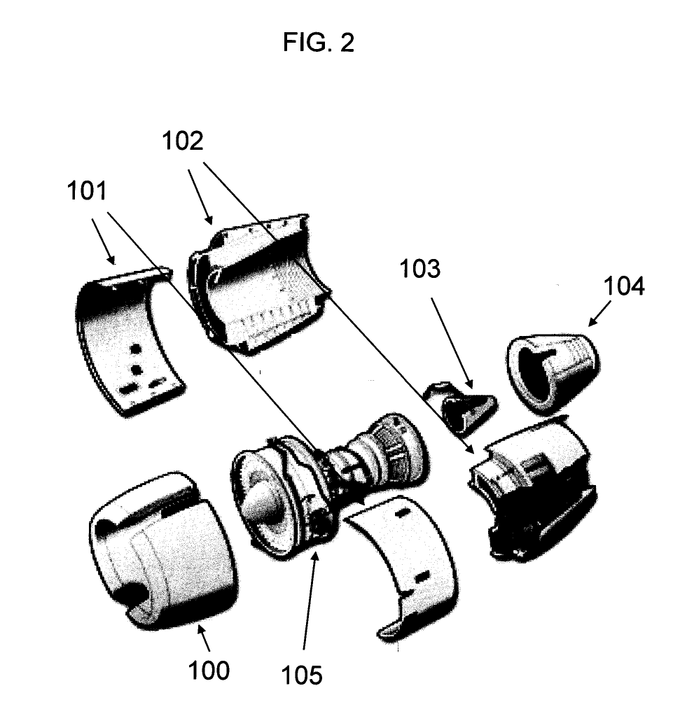

Several examples of composite structures that would benefit from being manufactured from the disclosed fiber reinforced thermoset plastic composites can be found in a jet engine nacelle. With reference to FIG. 2, jet engine nacelles are typically made of metallic or composite articles including an inlet 100, fan cowls 101, thrust reversers 102, an exhaust cone 103, an exhaust nozzle 104 that together encase the jet engine and related systems 105 (such as the compressor, combustor and turbine components of the jet engine). The current generation of composite nacelles is made using aerospace grade epoxies impregnating carbon fiber. However, due to thermal and corrosive degradation of these structures, they require secondary protection against both adding weight, bulk and increased maintenance concerns. The disclosed fiber reinforced composite are particularly adapted for use in producing components of a jet engine nacelle.

B. Pre-Ceramic Resins

Pre-ceramic resins suitable for use in the disclosed fiber reinforced thermoset plastic composite materials and methods of making such composites should be thermosetting plastics. Thermoset resins are sometimes referred to as thermoset polymers, and for the purposes of this disclosure “thermoset polymer” and thermoset resin are used interchangeably. “Thermoset” or “thermosetting,” means that the resin solidifies or crosslinks, and generally, cannot be reformed with the application of heat like a thermoplastic. The pre-ceramic thermosetting resins for use in the disclosed composites and methods of making such composites should also be resistant to heat (for example, they are not decomposed and/or adversely affected by exposure to elevated temperature, such as temperatures in excess of about 300° C.). The pre-ceramic thermoset resins useful for making the fiber reinforced thermoset plastic composites disclosed herein generally have a viscosity of at least about 20 centipoise (cps) at about 25° C., such as greater than about 20 cps, greater than about 50 cps, greater than about 100 cps, greater than about 200 cps, greater than about 300 cps, greater than about 400 cps, or even greater than about 450 cps at about 25° C. However, both more and less viscous materials can be employed. While the resins typically flow freely without added solvent, the viscosity can be reduced, if desired, by the addition of an organic solvent, such as an aromatic hydrocarbon solvent, for example, toluene or xylene, an aliphatic hydrocarbon solvent, such as heptane, decane, or dodecane, an ether solvent, such as tetrahydrofuran or anisole, an ester solvent, such as hexyl acetate or butyl propionate, or a ketone solvent such as acetone, methylethylketone, and the like.

The preferred pre-ceramic thermoset resins for use in producing the disclosed fiber reinforced thermoset plastic composites are characterized as pre-ceramic resins. “Pre-ceramic” means that the resins can be converted to a ceramic material by pyrolysis. One aspect of the disclosed embodiments is that the pre-ceramic thermosetting resins can be crosslinked to form a fiber reinforced thermoset plastic composite in the absence of pyrolysis. Such thermosetting resins should preferably be solvent-free in order to avoid the problems incident to the use of solvents, such as bubbles or spaces left in the composite after crosslinking. However, some useful composites have been made from the subject resins that included the use of solvents.

The thermosetting pre-ceramic resins suitable for use in the manufacture of the disclosed fiber reinforced thermoset plastic composites are developed from one of a number of pre-ceramic resins, including and not limited to, polysilazanes such as perhydropolysilazanes, methylhydridocyclosilazanes, alkylhydridocyclosilazanes, and polyureidosilazanes, polysiloxanes polymethylsilsesquioxanes, polyvinylsilsequioxanes, polyphosphazines, polyborosilanes, polycarbosilazanes, methylpolycarbosilane, vinylpolycarbosilanes, methylvinylpolycarbosilane, polytitanocarbosilane, allyl hydridopolycarbosilanes, hydridopolycarbosilane, ureamethylvinylsilazanes, polyvinylsiloxanes, polymethylsiloxanes, polycarbosilanes, polyphenylene, dialkylsilane polymers, acetylene-based polymers, including monofunctional and/or bifunctional acetylenes variants, derivatives and combinations thereof. Such polymers may be present in compositions, for example containing a catalyst. Moreover, the resins above and their derivatives and variants may include halides and may be present in halide-containing compositions. Preferred pre-ceramic thermoset resins include polysilazane based polymers, polycarbosilane based polymers, or combination thereof. Suitable pre-ceramic thermoset resins can be synthesized by methods well known in the art (see for example U.S. Pat. Nos. 4,312,970; 4,482,699; 5,055,431; 5,086,126; 5,153,295; 5,464,918; 6,329,487; 6,652,978; and 6,730,802 and U.S. Patent Publication Nos. 2003/0113447 and 2006/0004169, the disclosures of which are incorporated herein to the extent that they disclose pre-ceramic resins) or can be purchased from a variety of manufacturers including KION®, Starfire Systems, Inc., Clariant, Gelest Inc. and Dow Chemical, amongst others.

In one example, U.S. Pat. No. 6,329,487 describes a process for preparing novel ammonolysis products (polysilazanes) by introducing a starting compound containing at least one silicon-hydrogen bond, such as a halosilane, into a stoichiometric excess of anhydrous liquid ammonia. It is currently believed that an ammonium halide is generated and acts as an acid catalyst to provide an ionic and/or acidic environment for preparing the novel ammonolysis compounds. The prepared ammonolysis products are retained in a separate liquid-phase layer and distinct from the anhydrous liquid ammonia containing the ionized ammonium halide. Also provided in U.S. Pat. No. 6,329,487 are methods to purify ammonolysis products and to modify ammonolysis products by controllably increasing viscosity from a liquid to a solid and viscosities therebetween. The resulting polysilazane has a distinctive ammonia or ammonia-like odor characteristic of ammonolysis products.

Particularly useful pre-ceramic resins include polysilazane-based polymers, polycarbosilane-based resins and/or combinations thereof. In general the polysilazanes are characterized by a formula

—(SiR¹R²—NR³)ₙ—(SiR⁴R⁵—NR⁶)ₚ—(SiR⁷R⁸—NR⁹)_{q}—

In particular examples, the polysilazane has the formula

—(SiR¹R²—NR³)ₙ—(SiR⁴R⁵—NR⁶)ₚ—

or

—(SiR¹R²—NR³)ₙ—

or even

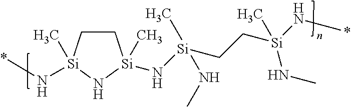

In certain examples, n, p, and q are integers selected so that the polysilazane has a number-average molecular weight of about 150 to about 150,000 g/mol. In other examples, n, p, and q are integers selected so that the polysilazane has a number-average molecular weight of about 1,500 to about 150,000 g/mol. In still other examples, n, p, and q are integers selected so that the polysilazane has a number-average molecular weight of about 15,000 to about 150,000 g/mol. The number-average molecular weight of the polymer is chosen such that the pre-ceramic resin has the desired characteristics, for example viscosity. In this context an integer such as n, p, and q can be 0 (zero) or a positive whole number. The substituents R¹, R², R³, R⁴, R⁵, and R⁶ can independently be hydrogen, or an optionally substituted alkyl, aryl, vinyl or (trialkoxysilyl)alkyl radical. The choice of R¹, R², R³, R⁴, R⁵, and R⁶ is dictated by the desired properties of the thermosetting resin either prior to crosslinking or after crosslinking. For example, the choice of R¹, R², R³, R⁴, R⁵, and R⁶ can affect the viscosity of uncrosslinked polymer and also the degree of polymer crosslinking in the final product after crosslinking. Thermoset polymer crosslinking can be induced by a variety of methods including but not limited to heat activation, activation by electromagnetic radiation (such as ultraviolet light, laser light, infrared radiation, and/or microwave radiation), the addition of crosslink initiators, or a combination thereof.

In some embodiments, the pre-ceramic thermosetting resin contains additional additives, for example, nanoparticles, polysiloxanes, polysilsesquioxanes, and/or other thermosetting resins; such as, without limitation, epoxies, phenolics, resorcinolics, epoxy vinyl esters, and/or crosslink initiators. “Crosslink initiator” means a compound or composition that is capable of inducing the formation of crosslinks in the pre-ceramic resin. In some examples, crosslink initiators can be activated by electromagnetic radiation such as ultraviolet light, laser light, infrared radiation, and/or microwave radiation.

In some examples, the crosslink initiator contains a free-radical polymerization initiator, such as a catalyst. In some embodiments, the free-radical polymerization initiator contains an azo compound such as 2,2′-azobis(2,4-dimethylvaleronitrile)), 2.2′-azobis(2-methylpropanenitrile), 2,2′-azobis(methylbutyronitrile), and 1,1′-azobis(cyanocyclohexane). Typically, these azo compounds can be used at about 0% to about 10% by resin weight, such as greater than about 0%, about 1%, about 2%, about 3%, about 4%, about 5%, about 6%, about 7%, about 8%, about 9%, or about 10% depending upon which azo compound is being used and the desired outcome. As will be recognized upon consideration of the present disclosure, an amount set forth above, or even an amount of an azo compound greater than 10%, can be used, depending upon factors appreciated by those of skill in the art, such the azo compound or compounds being used, the resin formulation, and the desired outcome.

In some embodiments, the free-radical-type of polymerization initiator contains peroxide, such as dialkyl peroxide, peroxideketal, diperoxyester, alkyl peroxester, peroxycarbonate, isopropyl benzene peroxide or a combination thereof. In particular embodiments, isopropyl benzene peroxide is used. Typically, these peroxides can be used at a concentration of greater than about 0% to about 10% by resin weight, such as from greater than about 0%, about 1%, about 2%, about 3%, about 4%, about 5%, about 6%, about 7%, about 8%, about 9%, or about 10%. As will be recognized upon consideration of the present disclosure, the appropriate amount of a peroxide used can be selected and can be greater than 10%, depending upon factors appreciated by those of skill in the art, such the peroxide compound or compounds being used, the resin formulation, and the desired outcome.

In some examples, the crosslink initiator includes a radical or cationic photo-initiator. Examples of radical and cationic photo-initiators that can be used in the disclosed methods and thermoset plastic composites include, without limitation, benzophenone, diphenoxy benzophenone, amino and haloganted functional bezophenones, derivatives thereof such as anthraquinone, fluorenone, thioxanthone, and zanthone, camphorquinone, benzyl, alkyl ethers of benzion, benzil dimethyl ketal, 2-hydroxy-2-methylphenol-1-propanone, 2,2-diethoxyacetophenone, 2-benzyl-2-N,N-dimethylamino-1-(4-morpholinophenyl)butanone, benzimidazoles, acylphosphine oxides, bis-acyl phosphine oxides, halogenated acetophenone derivatives, sulfonyl chlorides of aromatic compounds, and mixture of 2,4,6-trimethylbenzophenone and 4-methylbenzophenone, amongst others. Typically, these photo-initiators can be used in an amount from greater than about 0% to about 10% by resin weight, such as greater than about 0%, about 1%, about 2%, about 3%, about 4%, about 5%, about 6%, about 7%, about 8%, about 9%, or about 10% depending upon which photo-initiator is being used and the desired outcome.

In some examples, the crosslink initiator includes a photo-initiator. Examples of useful photo-initiators for producing the desired crosslinking include 2,2-diethoxy-1-phenylethanone, 2,2-dimethoxy-2-phenylacetophenone, 4,4′-dihydroxybenzophenone, 2,2-diethoxyacetophenone or combinations thereof. Typically, these photo-initiators can be used at about 0% to about 10% by resin weight, such as about 0%, about 1%, about 2%, about 3%, about 4%, about 5%, about 6%, about 7%, about 8%, about 9%, or about 10% depending upon which photo-initiator is being used and the desired outcome. In certain embodiments the amount of a photo-initiator can be greater than 10% if desired. The suitable amount of a photo-initiator can be selected by those of skill in the art upon consideration of the present disclosure and factors such as, the photo-initiator or photo-initiators being used, the resin formulation and the desired outcome.

In some embodiments, “end capping” (for example chain termination) of the polysilazane based and/or polycarbosilane based polymer is employed. Without limiting the disclosure to a particular theory of operation, this may increase the free-volume around the reactive groups of the polysilazane and/or polycarbosilane based polymers so they do not get trapped in a rigid matrix before they get a chance to react. In some embodiments, specific “end caps” are employed to impart hydrophobicity to the polysilazane and/or polycarbosilane based polymers. This hydrophobicity has been found useful to control, reduce and/or eliminate the “free ammonia” that can be generated from the resin during processing and/or use. The method and type of “end capping” will vary depending upon the desired outcome of the polymer. It is well known to those of ordinary skill in the art that these end caps can be formed through processing methods (for example by controlling temperature, pressure and atmosphere) without the inclusion of additional materials, or with the inclusion of additional materials. In some embodiments, functional “end caps” are provided by processing the polysilazane based polymer and/or the polycarbosilane based polymer under vacuum and/or under pressure and/or cycles of both. In some embodiments, functional “end caps” are provided by the inclusion of additional compounds. These useful compounds include (without limitation) melamine, urea, phenol, resorcinol, phenol-formaldehyde (pf) resins, resorcinolinic (pro resins, epoxides, epoxies, polysiloxanes, polybenzoxaines, amines, and some nanoreinforcements; such as nanoclays, certain amine structures and certain amine polyhedral oligomeric silsesquioxane (POSS) structures. It has been discovered that a particularly useful POSS is heptaisobutyl-(3-(2-aminoethyl)amino)propyl to impart hydrophobicity to control, reduce and/or eliminate the “free ammonia” that can be generated from the resin during processing and/or use. It has been discovered that this POSS also acts as a free-radical polymerization initiator. Thus, in some embodiments the pre-ceramic resins contain a POSS.

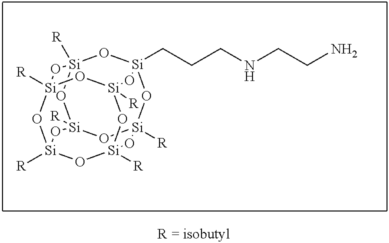

### (3-(2-aminoethyl)amino)propyl-heptaisobutyl POSS

Typically, the pre-ceramic resins are capable of being crosslinked at a temperature of between about 0° C. and about 300° C. In some embodiments, the pre-ceramic resin is crosslinked at a temperature less than about 300° C. such as less than about 250° C., less than about 200° C., less than about 150° C., less than about 100° C., less than about 75° C., less than about 50° C., or even less than about 25° C. In some embodiments, the pre-ceramic resin is crosslinked at room temperature, which is about 22° C. In some embodiments, the pre-ceramic resin is crosslinked in air. However, under certain situations it may be desirable to crosslink the resin in a defined atmosphere, for example an inert atmosphere. Typically, the resin can be crosslinked at a pressure of about 0.1 bar to about 10 bar.

C. Reinforcing Fibers

Reinforcements (such as textiles, cloth, woven roving, rovings, filament winding glass, etc.) and reinforcing fibers that have been found useful are well-known to those skilled in the art. The fiber-reinforced thermoset plastic composites disclosed herein can be formed using fiber made from a variety of materials, as long as the fibers have the property of being heat resistant (such that they are not decomposed and/or adversely affected by exposure to elevated temperature, such as temperatures in excess of about 500° C. to about 1000° C.). All reinforcements employ the use of sizing materials to allow the manufacture of the desired reinforcement without breakage. The sizing material (sizing materials also are known as coupling agents) selected contributes to the service temperature at which the reinforcement can operate. However, it has been found that some normally less thermally stable reinforcements, such as e-glass, have benefited from the thermal resistance of the pre-ceramic resins to become able to withstand higher than expected thermal exposure without degradation. Examples of suitable materials include materials made from metal, glass (such as E-glass, or S-glass, etc.), ceramic (such as TYRANO®, SYLRAMIC®, NICALON®, NEXTEL®, mullite and the like), carbon (such as carbon fiber, carbon nano-fibers, carbon nanotubes and the like), fibers (ceramic and pre-ceramic) made from ceramic pre-cursor materials, quartz fibers, mineral fibers (such as basalt fibers, etc.), or blends thereof. Particularly useful fibers include fibers made from SiC, SiCN, Si₃N₄, Al₂O₃, and in particular basalt and basalt in combination with other reinforcements.

The selection of the fiber material is dictated by the application of the finished product. In one example, a fiber material with a low coefficient of thermal conductivity is selected where the finished product is used as an insulator, for example when the finished product is used in the leading edge of a space shuttle wing. In another example, a fiber material with a high coefficient of thermal conductivity is selected where the finished product is used to dissipate heat, for example when the finished product is included in the exhaust nozzle of a jet engine.

In certain embodiments, fibers are pretreated or coated prior to infiltration with the pre-ceramic resin, for example to ensure that the polymer will adhere and/or coat the fibers. Therefore, the reinforcing fiber materials can be used in a coated or uncoated form. The fibers may be coated one, two, or even more times. Successive coatings may be the same or different depending on the desired characteristics of the resultant materials. Examples of suitable coatings include polysilazane based coatings, polycarbosilane based coatings and combinations thereof. Coatings may be applied at any stage during the manufacturing and/or processing of the fibers.

The reinforcing fibers can be short fibers, long fibers or even continuous filament fibers. The fibers typically have a filament thickness of greater than about four microns.

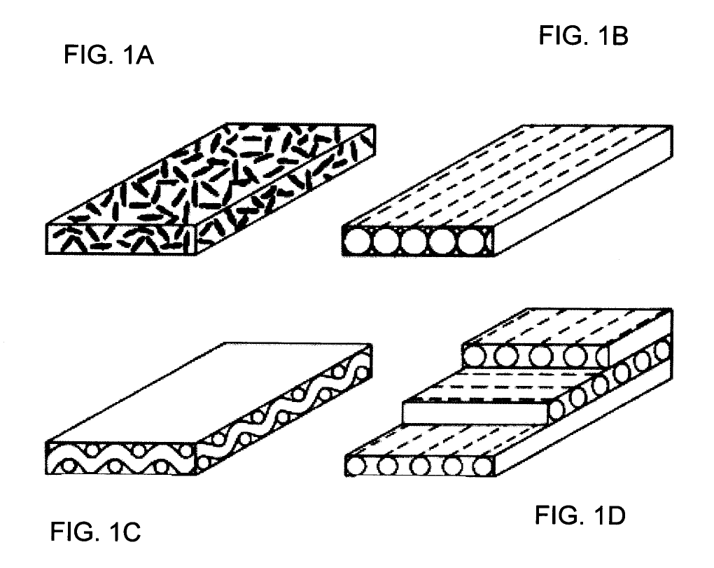

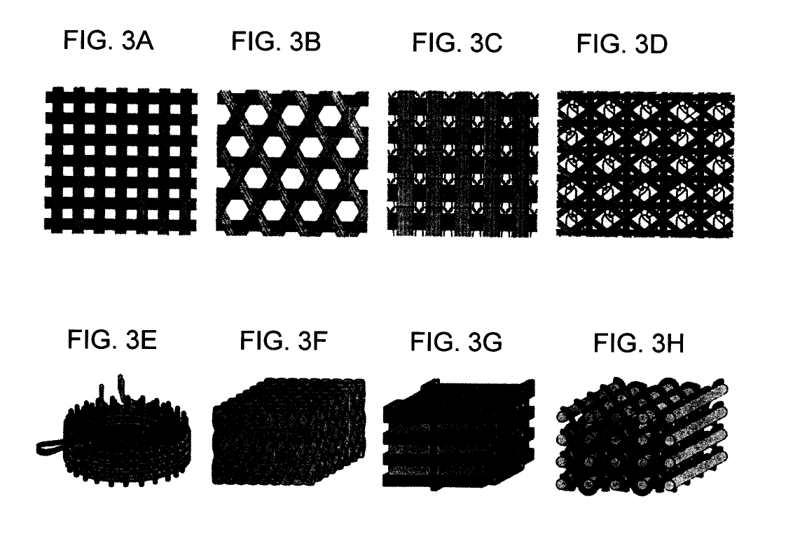

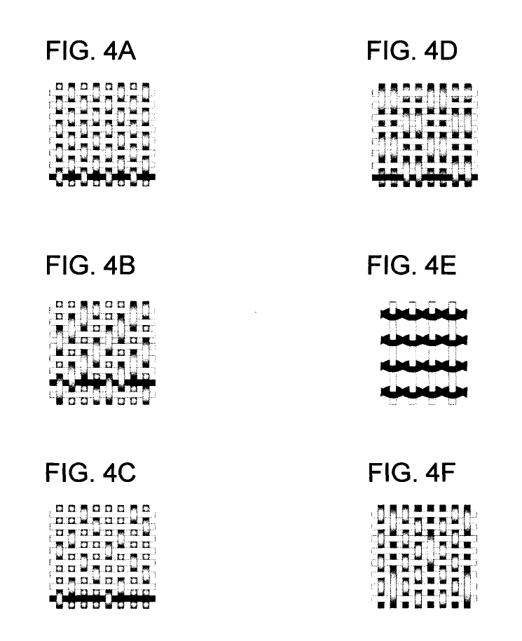

In certain applications ready-made textiles are utilized. Examples of suitable textiles include both woven and non-woven fabrics. For example, felt, unidirectional sheet (see for example FIG. 1B), unidirectional woven fabric, bi-directional woven fabric (see for example FIGS. 1C, 3A, and FIGS. 4A through 4F), multi-directional woven fabric (see for example FIGS. 3B, 3F, and 3G), knitted fabrics (see for example FIGS. 3C and 3D) amongst others may be used as reinforcing fibers. In some examples, the reinforcing fiber matrix includes a wound, woven, braided, or knit perform (see for example 3E and 3F), for example a preform that approximates the shape of the final composite article to be produced.

The fibrous structural reinforcement systems used for the disclosed fiber reinforced thermoset plastic composites can be divided into two classes, discontinuous and continuous. In continuous fiber reinforcement systems, the tow is formed into woven mats (cloths), uniaxial tapes or mats, windings (rovings), or knitted or braided performs amongst others. The fiber layers can be in the form of a woven roving or simply fiber in uniaxial or multiaxial orientation. They are often in the shape of the final article desired and referred to as a “perform”.

Woven mats and cloths have a layer of interlaced tows, primarily in two, usually orthogonal, principal directions, often referred to as the warp and weft. Uniaxial tapes or mats have a layer of tows ordered in a single direction (see for example FIG. 1 B), often held together with a binder. The use of woven mats or uniaxial tapes or mats in a fiber reinforced thermoset plastic composite can greatly increase the fiber reinforced thermoset plastic composite's tension capacity in the directions of the tows and strength in bending about the axes perpendicular to the tows directions. Continuous fiber reinforcement systems all share the advantage of improving the augmented structural capacity, particularly tension and bending, for the part overall when loaded in the tow's longitudinal directions. With two-dimensional continuous reinforcement systems (mats, tapes, and windings), flat or curved, the out-of-plane, interlaminar, tension capacity is usually dominated by the comparatively weak matrix material as no fibers run longitudinally in this direction. Fiber reinforced thermoset plastic composites utilizing woven mats and uniaxial tapes or mats are often laminates (for example made of multiple layers) often with varying tow orientations from layer to layer (see for example FIG. 1 D), thus imparting multidirectional strength.

The reinforcement system orientations may be chosen such that the structural properties are roughly uniform about the surface normal, particularly for parts with a thickness that is substantially smaller than its other dimensions. Windings are normally used to maximize the circumferential structural properties, particularly tension, of cylinders, tubes (such as pipes) or spheres. In windings, tows are coiled about a radius.

Knitted or braided preforms are often used for regularly shaped three-dimensional parts. The disclosed thermoset plastic composites can be prepared either as continuous composites or by batch manufacture. In some embodiments, a continuous composite is formed from a continuous preform (roving or strands), for example a composite fabricated by pultrusion. The preform can include fibers orientated in any direction and complex weaving patterns can be accommodated.

The second class of fiber structural reinforcement systems used for fiber reinforced thermoset plastic composites is discontinuous fiber reinforcement systems. Discontinuous fiber reinforcement systems include chopped yarn or chopped tows, collectively known as chopped fibers. Useful lengths for the chopped fibers typically range from about 3 mm to about 50 mm. Typically, the chopped fibers are randomly disposed throughout the fiber reinforced thermoset plastic composite by a variety of methods with varying degrees of complexity (see for example FIG. 1A). One simple method is to fill a mold with the desired amount of chopped fibers, add the appropriate amount of pre-ceramic thermoset resin, apply the pressure required for the desired fiber compaction, and crosslink the resin. A more complicated method would be to slurry the chopped fibers in the resin, then inject this slurry, under pressure, into a mold, where the resin is crosslinked.

Other forms of discontinuous fiber reinforcement systems are random or semi-random mats. Random mats have lengths of fiber randomly distributed in a layer with binders to yield a cohesive mat. The fibers in a random mat originate and end in the same layer. Random mats are employed in the manufacture of composites much like cloth mats. In some embodiments, a felt mat, a mat of mechanically interlocked filaments having a semi-random orientation, is employed. By “interlocked” it is meant that the filaments of the felt are engaged such that the relative motion between fibers is constrained. By “semi-random” it is meant that the filaments are generally randomly oriented in the felt, although they are constrained to the thickness of the felt.

In some embodiments, the disclosed fiber reinforced thermoset plastic composite materials contain a plurality of layers, such as two, three, or more layers. It will be evident that the thickness of the composite can vary widely. In some examples, the layers are of the same material, for example all basalt fibers. In other examples, the layers are of different materials, such as two, three, or even more materials, for example a basalt layer and a carbon layer. It is also contemplated that the plurality of layers can be of different fabric types, for example one or more layers of felt and one or more layers of unidirectional fabric. In some applications the fiber reinforced thermoset plastic composites are made with both continuous and non-continuous fiber reinforcement. The thermosetting pre-ceramic resin can be layered between two layers and adhere them together. The specific material, number of layers and type of fabric layers is selected based on the application of the article that is formed.

D. Composite Manufacturing Processes

One advantage of the fiber reinforced thermoset plastic composites disclosed herein is they can be can be manufactured by processes typical for traditional composite manufacturing. Therefore, existing manufacturing facilities can be utilized without the need for costly retooling. Traditional composite manufacturing techniques are well-known to those of ordinary skill in the art and include, without limitation, hand lay-up, filament winding, vacuum bagging, resin transfer molding (RTM), and vacuum assisted resin transfer molding (VARTM), although any process can be utilized that results in a fiber reinforced thermoset plastic composite. It is contemplated that these techniques are not mutually exclusive and can be used simultaneously with one another. In some examples, the fiber reinforcing material is pre-impregnated (prepreg) with pre-ceramic resin prior to formation of shaped article. Pre-ceramic resin impregnated reinforcing fiber (such as filaments), fabric or mat can be made as a prepreg and stored for later use, for example in a mold, winding, or hand lay-up.

Hand lay-up is the simplest and oldest open molding method of the composite fabrication processes. Typically components or successive plies of fiber reinforcing material or thermosetting pre-ceramic resin impregnated reinforcements are applied to a mold, and the composite is built up and worked by hand. Crosslinking is normally at ambient temperatures, but may be accelerated by heating or the addition of crosslink initiators, if desired. Typically reinforcing fibers such as reinforcing mat or woven fabric or roving is positioned manually into a single-sided open mold, and pre-ceramic resin is poured, brushed, or sprayed over and into the fibers. Pre-ceramic resin can be forced through the thickness of the fiber mats using hand rollers. Typically, entrapped air and/or excess pre-ceramic resin is removed manually with squeegees or rollers to complete the structure. The part is allowed to crosslink and then disassembled from the mold. Since this process is not typically performed under the influences of heat and pressure, simple equipment and tooling can be employed.

Vacuum bag molding, a refinement of hand lay-up, uses a vacuum to eliminate entrapped air and excess pre-ceramic resin. After the lay-up is fabricated on either a male or a female mold form, a non-adhering film typically is placed over the lay-up and sealed at the mold flange. A vacuum is drawn on the bag formed by the film while the composite is crosslinked at room or elevated temperatures. Compared to hand lay-up, the vacuum method provides higher reinforcement concentrations, better adhesion between layers, and more control over resin/fiber ratios.

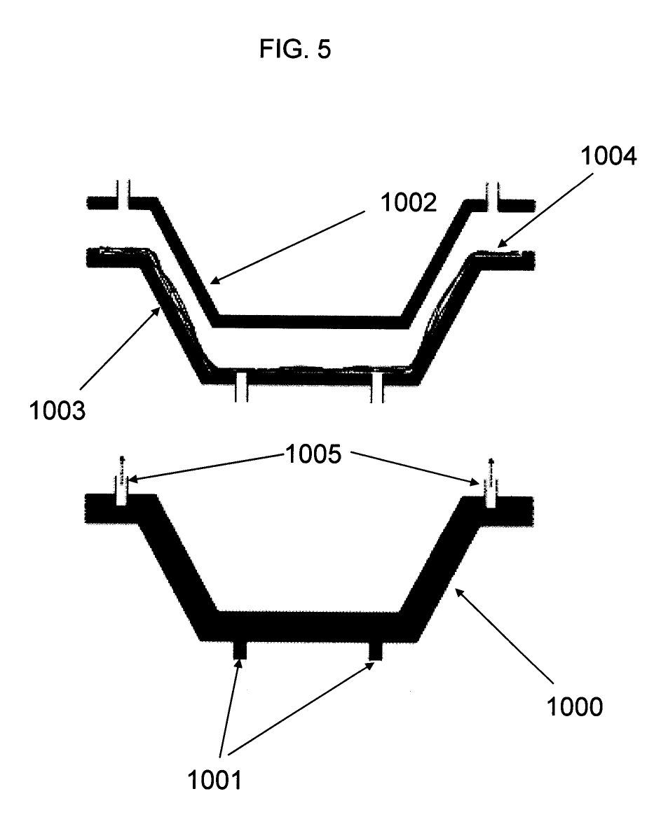

Resin transfer molding (RTM), also known as resin-injection process, is a closed-mold pressure injection system. The process uses pre-ceramic resin and is compatible with most reinforcement material types such as continuous strand, cloth, woven roving, long fiber and chopped strand amongst others. With reference to FIG. 5, the process typically consists of filling a rigid and closed mold 1000 cavity by injecting a pre-ceramic resin through one, or several, points 1001, depending on the size of the component formed by the male 1002 and female 1003 portions of the mold 1000. The reinforcements 1004 are previously placed in the interior of the mold 1000, before closing and locking it firmly. Different types of molds can be used, depending on the required production rate. Heat can be applied to the mold to shorten the crosslinking-time, in which case steel molds may be necessary. The reinforcements may be continuous filament mats, complexes or fabrics, but generally continuous filament mats are used. The use of preforms from continuous strand mats permits a considerable increase in production rate to be achieved. In some examples a vacuum 1005 can be applied.

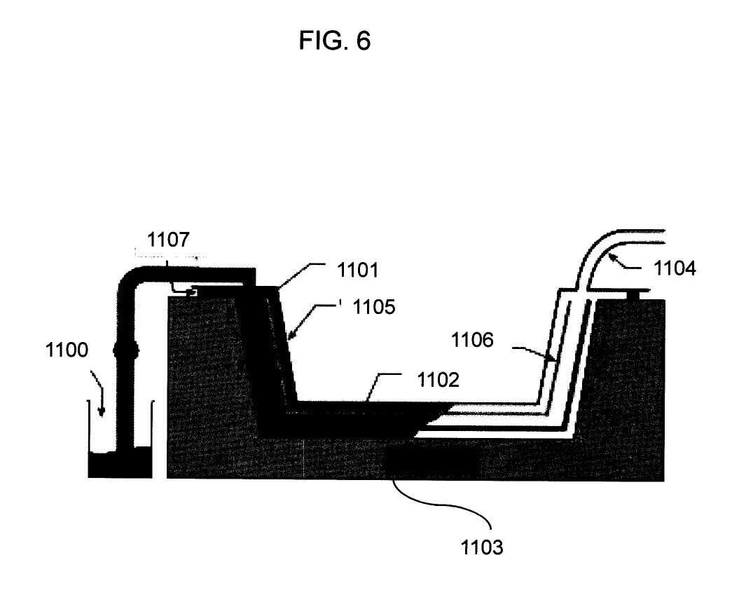

The use of pre-preg and autoclaves for the crosslinking of high performance composite structures has been the state of the art for over 30-years. Recently, the aerospace industry has reduced production costs for composite aircraft components by using Vacuum Assisted Resin Transfer Molding (VARTM) manufacturing process to produce aerospace grade composite structures. With reference to FIG. 6, VARTM is a process wherein liquid pre-ceramic resin 1100 is transferred 1101 into a dry fiber preform 1102 located in a mold cavity 1103 that has only a single-sided tool surface using a vacuum 1104. VARTM parts are formed in an open cavity mold, so not all surfaces are molded to the tool. The opposite side to the tool surface is primarily a vacuum bag surface 1105 comprised of transfer media, peel ply fabric, bleeder/breather media 1006, and sealant tape 1107. The single sided tools can be typically computer numerical control (CNC) machined to high tolerances, so the molded surfaces can be complex in shape and very precise. This may be important for many large components that require control of dimensions, tolerances on only one surface and where surface finish is important. With complex geometries, there are techniques such as caul plates for simultaneously applying vacuum bag pressure (typically about 15 psi) to complex surfaces of different orientation. Caul plates used in the VARTM process are mainly to control thickness critical areas on the vacuum bag surface of the laminate.

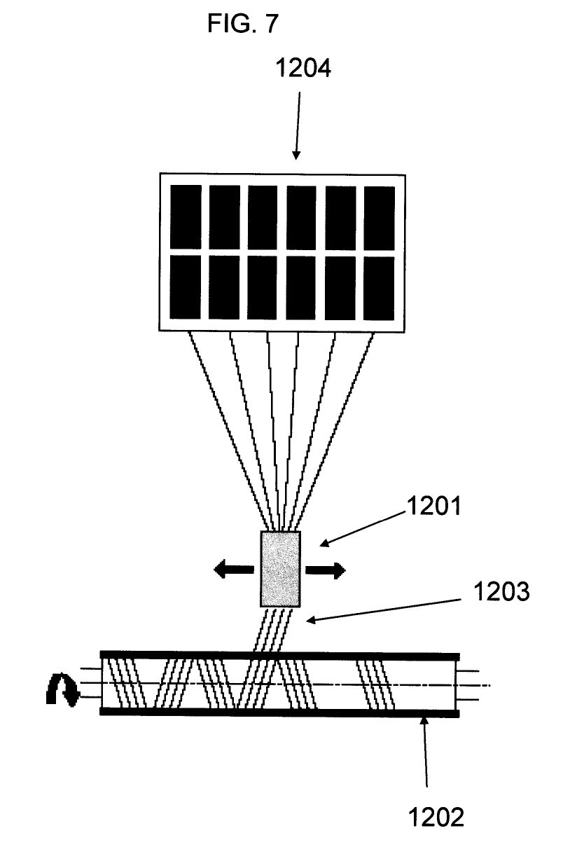

In filament winding applications, continuous fiber reinforcement, generally based on single-end rovings, is wrapped around a suitable mandrel. The shape of the final article is dictated by the shape of the mandrel. With reference to FIG. 7, in one example a filament winding machine 1201 wraps the mandrel 1202 with pre-ceramic resin-impregnated strands 1203 supplied from a roving creel 1204 with the required amount and orientation to build the designed reinforced structure. It is also contemplated that the filament winding can be applied dry and the resin applied in a subsequent step. Filament winding typically produces hollow items like tubes, pipes, elbows, tanks, vessels. Fiber reinforcement is generally single-end rovings disposed on a creel. Through guiding and tensioning systems, strands are unwound under controlled conditions. In some examples, filament winding uses pre-impregnated filaments. “Full bath” or “transfer roller” systems impregnate and control the amount of resin on the filament strand. Impregnated strands are therefore accurately wound in several layers on the rotative mandrel with an automated filament winding machine. After this wet winding step, the mandrel wrapped with the composite structure is crosslinked while in rotation. Once crosslinked resin polymerization has been completed and the mandrel is removed. The mandrel may sometimes be kept in the final composite item (“liner” part).

Filament winding applications can also be used to produce the disclosed fiber reinforced composites having braided fiber structures. A unique feature of the braiding process is its ability to combine continuous fibers in an oriented pattern over a mandrel of nearly any shape or size. The braiding process creates an interlaced structure of continuous fibers, providing stability to the preform and desirable strength-to-weight properties in the final part. Formation of the braid under tension produces compaction of plies and eliminates the potential for wrinkling and pinching.

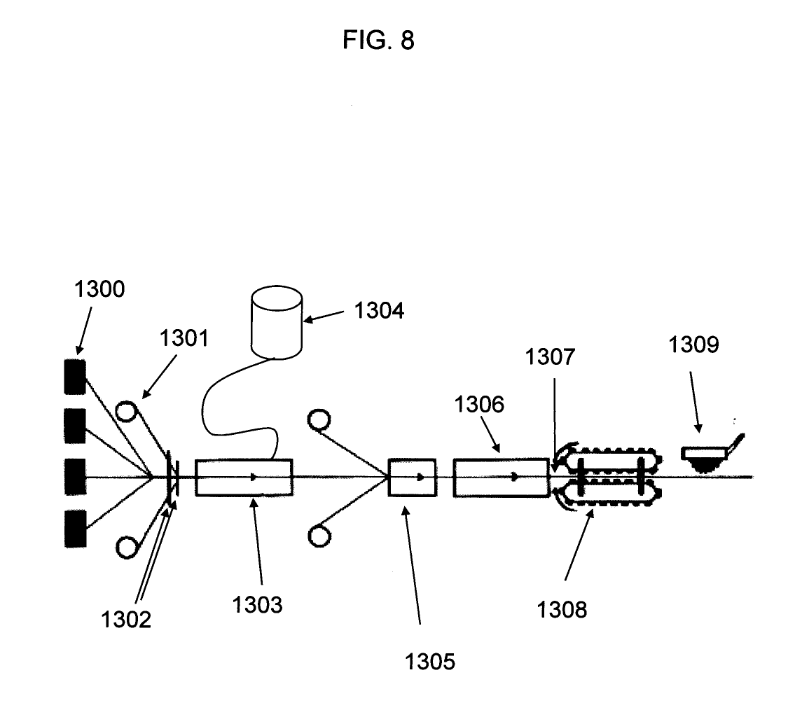

Another example of a method for making the disclosed fiber reinforced thermoset plastic composites is pultrusion. Pultrusion is a continuous method for making various reinforced plastic shapes of uniform cross sections. With reference to FIG. 8, in one example fiber reinforcements, such as unidirectional rovings 1300 and/or multi-directional glass fiber mat 1301, are guided with guides 1302 through a liquid pre-ceramic resin bath 1303 pumped from a reservoir 1304 to thoroughly wet the fiber. Then the fibers are formed, or shaped, with a performer 1305 into the profile to be produced before entering a die 1306. As the material progresses through the die 1306, which is shaped to match the design profile, the pre-ceramic resin changes from a liquid to a gel, and finally, into a crosslinked rigid composite 1307. A pulling device 1308 grips the crosslinked, rigid composite 1207 and literally pulls it through the die 1306, hence, the name pultrusion. After the crosslinked, rigid composite 1307 passes through the puller 1308 it is cut to a desired length with a cutter 1309. Pultrusion is ideally suited for custom shapes, some standard products include rods, bars, angles, channels, and I-beams.

### EXAMPLES

The following examples are provided to illustrate certain particular features and/or embodiments. These examples should not be construed to limit the invention to the particular features or embodiments described.

The following examples were prepared using pre-ceramic resins of polysilazane, polycarbosilane, and combinations thereof having varying viscosities. In certain examples the thermosetting polymers include free-radical accelerators and/or photo-initiators and/or “end capping”. Using thermal-mechanical analysis (TMA), the target glass transition temperature (Tg) was established to be greater than about 500° C., although results with a lower Tg would not necessarily disqualify the candidate pre-ceramic resins for use depending upon the desired applications. The target tensile strength was established to be greater than 60,000-psi, although results with a lower tensile strength would not necessarily disqualify the candidate pre-ceramic resins for use depending upon the desired applications. The materials were tested where indicated using the American Society for Testing and Materials (ASTM) test procedures for tensile strength (ASTM D683), flexural strength (ASTM D790), compression (ASTM D695), flammability (ASTM E162), smoke generation (ASTM E662), and glass transition by TMA (ASTM E831) as set forth in the “Annual Book of ASTM Standards” published by ASTM International, West Conshohocken, Pa., USA.

### Example 1

A basalt fiber fabric was impregnated with a polysilazane based pre-ceramic resin with a viscosity of less than 100 cps. Ten fiber mats were laminated and pressed together in a platen press. The fiber reinforced thermoset plastic composite laminate was subsequently crosslinked for 3 hours at about 1.5 bar and 150° C. The thickness of the laminate was about 2.5 mm.

### Example 2

A basalt fiber fabric was vacuum infused with a polysilazane based pre-ceramic resin with a viscosity of approximately 450 cps. Ten fiber mats were laminated and pressed together in a platen press. The fiber reinforced thermoset plastic composite laminate was subsequently crosslinked for 3 hours at about 1.5 bar and 150° C. The thickness of the laminate was about 2.5 mm.

### Example 3

The procedure was as in Example 1, with the difference that a carbon fiber fabric was used instead of a basalt fabric. The glass transition temperature of the laminate with a thickness of about 2.5 mm was determined to be in excess of 650° C. by TMA using the ASTM E831 testing protocol. In addition, the stress properties were measured: the composite material resisted a pressure stress of 22,425 bar at 23° C. and 45% relative humidity and a pressure stress of 8,625 bar at 450° C. and 45% relative humidity.

### Example 4

The procedure was as in Example 2, with a carbon fiber fabric being used instead of a basalt fabric. The glass transition temperature of the laminate with a thickness of about 2.5 mm was determined to be greater than 650° C. by TMA using the ASTM E831 testing protocol. In addition, the stress properties were measured using the ASTM compression test (ASTM D695). The composite material resisted a pressure stress of greater than 25,000 bar at 23° C. and 45% relative humidity and a pressure stress of greater than 9,000 bar at 450° C. and 45% relative humidity using the ASTM compression test (ASTM D695).

### Example 5

A carbon fiber fabric laminate schedule was impregnated with a polysilazane/polycarbosilane pre-ceramic resin of 350 cps. The fiber reinforced thermoset plastic composite laminate was subsequently crosslinked for 3 hours at about 1.5 bar and 150° C. The glass transition temperature of the laminate with a thickness of about 2.5 mm was determined to be in excess of 650° C. by TMA using the ASTM E831 testing protocol. In addition, the stress properties were measured: the composite material resisted a pressure stress of 22,425 bar at 23° C. and 45% relative humidity and a pressure stress of 8,625 bar at 450° C. and 45% relative humidity using the ASTM compression test (ASTM D695).

### Example 6

A prepreg was made utilizing carbon fiber and a polysilazane pre-ceramic resin. The prepreg was cut and placed on top of a caul plate and then under a vacuum of greater than 1 pounds per square inch (psi) and greater than 30 psi. This was place into an oven and crosslinked at less than 200° C. for approximately three hours. The resulting fiber reinforced thermoset plastic composite resisted a pressure stress of greater than 20,000 bar at 23° C. and 45% relative humidity using the ASTM compression test (ASTM D695). The resulting Tg was greater than 650° C. as measured by TMA using the ASTM E831 testing protocol.

### Example 7

A prepreg was made utilizing carbon fiber and a polysilazane pre-ceramic resin. The prepreg was cut and placed on top of a caul plate and then under a vacuum of greater than 30 psi and greater than 100 psi. This was place into an oven and crosslinked at greater than 250° C. for approximately three hours. The resulting fiber reinforced thermoset plastic composite resisted a pressure stress of greater than 25,000 bar at 23° C. and 45% relative humidity using the ASTM compression test (ASTM D695). The resulting Tg was greater than 650° C. as measured by TMA using the ASTM E831 testing protocol.

### Example 8

A filament wound part was made using carbon filament winding glass and a polycarbosilane pre-ceramic resin of 450 cps and crosslinked at less than 200° C. for approximately 3 hours. The resulting fiber reinforced thermoset plastic composite resisted a pressure stress of greater than 21,000 bar at 23° C. and 45% relative humidity using the ASTM compression test (ASTM D695). The resulting Tg was greater than 650° C. as measured by TMA using the ASTM E831 testing protocol.

### Example 9

A filament wound part was made using carbon filament winding glass and a polysilazane pre-ceramic resin of 400 cps and crosslinked at less than 200° C. for approximately 3-hours. The resulting fiber reinforced thermoset plastic composite resisted a pressure stress of greater than 20,000 bar at 23° C. and 45% relative humidity using the ASTM compression test (ASTM D695). The resulting Tg was greater than 650° C. as measured by TMA using the ASTM E831 testing protocol.

### Example 10

A hand lay-up was made utilizing carbon fiber reinforcements and a polysilazane pre-ceramic resin of 450 cps and allowed to crosslink at room temperature utilizing a photo-initiator. This part was post-crosslinked at 200° C. for greater than 2 hours. The resulting fiber reinforced thermoset plastic composite resisted a pressure stress of greater than 18,000 bar at 23° C. and 45% relative humidity using the ASTM compression test (ASTM D695). The resulting Tg was greater than 650° C. as measured by TMA using the ASTM E831 testing protocol.

### Example 11

A hand lay-up was made utilizing carbon fiber reinforcements and a polysilazane polycarbosilane pre-ceramic resin of 450 cps and allowed to crosslink at room temperature utilizing a photo-initiator. This part was post-crosslinked at 200° C. for greater than 2 hours. The resulting fiber reinforced thermoset plastic composite resisted a pressure stress of greater than 18,000 bar at 23° C. and 45% relative humidity using the ASTM compression test (ASTM D695). The resulting Tg was greater than 650° C. as measured by TMA using the ASTM E831 testing protocol.

### Example 12

A laminate comprising 4 layers of basalt fiber fabric (200 g/m²), 4 layers of carbon fiber fabric and subsequently a further 4 layers of basalt fiber fabric was infiltrated as in Example 2, pressed and crosslinked for 2 hours at 150° C. and 1.5 bar. The resulting fiber reinforced thermoset plastic composite resisted a pressure stress of greater than 22,000 bar at 23° C. and 45% relative humidity. The resulting Tg was greater than 650° C. as measured by TMA using the ASTM E831 testing protocol.

### Example 13

A layer of basalt fiber fabric (200 g/m²) was infiltrated as in Example 1, and crosslinked for half an hour at 120° C. and standard atmospheric pressure. A very flexible cloth having very good heat resistance was obtained. The resulting Tg was greater than 650° C. as measured by TMA using the ASTM E831 testing protocol.

### Example 14

Five layers of basalt fiber fabric (200 g/m²) were infiltrated with a modified polysilazane, pressed in a TEFLON® coated mold and crosslinked for 3 hours at 150° C. and a pressure of 1.5 bar. It was subsequently no longer possible to separate the laminate from the TEFLON® surface; on application of great forces, the entire TEFLON® coating was removed together with the laminate, which indicates the extraordinarily strong adhesion of the laminate to TEFLON®. The resulting Tg was greater than 650° C. as measured by TMA using the ASTM E831 testing protocol.

### Example 15

Ten layers of a basalt fiber fabric (200 g/m²) were impregnated with the polysilazane pre-ceramic resin VL-10 obtained from Clariant, pressed and crosslinked for 3 hours at 150° C. and a pressure of 1.5 bar. The laminate exhibited similar properties to those mentioned under Example 3.

### Example 16

Ten layers of a basalt fiber fabric (200 g/m²) were impregnated with the polycarbosilane pre-ceramic resin SMP-10 obtained from Starfire Systems, Inc., pressed and crosslinked for 3 hours at 150° C. and a pressure of 1.5 bar. The laminate exhibited similar properties to those mentioned under Example 3.

### Example 17

A preform was made utilizing a combination of E-glass, carbon fiber and basalt. This preform was impregnated utilizing resin transfer molding with a polysilazane pre-ceramic resin and then crosslinked for 3-hours at less than 200° C. and a pressure of approximately 50 psi. The resulting fiber reinforced thermoset plastic composite had a Tg of greater than 600° C. as measured by TMA using the ASTM E831 testing protocol.

### Example 18

A preform was made utilizing basalt and carbon fiber reinforcements. This perform was place into a variable infusion molding process (VIMP) utilizing a stainless steel infusion media prior to the uppermost layer. A vacuum was drawn and the polysilazane pre-ceramic resin was infused into the laminate schedule. After infusion, the laminate was placed into an oven at less than 250° C. for three hours. After crosslinking, flexural stress testing was done to determine if there would be interlaminar shear at the stainless steel. None was found. The resulting fiber reinforced thermoset plastic composite had a Tg of greater than 600° C. as measured by TMA using the ASTM E831 testing protocol.

While this disclosure has been described with an emphasis upon particular embodiments, it will be obvious to those of ordinary skill in the art that variations of the particular embodiments may be used, and it is intended that the disclosure may be practiced otherwise than as specifically described herein. Features, characteristics, compounds, chemical moieties, or examples described in conjunction with a particular aspect, embodiment, or example of the invention are to be understood to be applicable to any other aspect, embodiment, or example of the invention. In view of the many possible embodiments to which the principles of the disclosed invention may be applied, it should be recognized that the illustrated embodiments are only preferred examples of the invention and should not be taken as limiting the scope of the invention. Accordingly, this disclosure includes all modifications encompassed within the spirit and scope of the disclosure as defined by the following claims.

1. A method for producing a non-ceramic fiber reinforced thermoset plastic composite, comprising:
providing a fiber material;
infiltrating the fiber material with a pre-ceramic resin comprising a polysilazane, a polycarbosilane or a combination thereof to produce an infiltrated fiber material; and
curing the infiltrated fiber material at an ultimate cure temperature of less than about 500° C. in the absence of pyrolysis to produce the non-ceramic fiber reinforced thermoset plastic composite.

2. The method of claim 1, wherein the ultimate cure temperature is less than about 400° C.

3. The method of claim 1, further comprising contacting the pre-ceramic resin with an amine polyhedral oligomeric silsesquioxane prior to curing.

4. The method of claim 1, wherein the pre-ceramic resin comprises a polysilazane having the formula
—(SiR¹R²—NR³)ₙ—(SiR⁴R⁵—NR⁶)ₚ—(SiR⁷R⁸—NR⁹)_{q}—
where n, p, and q are integers and are selected so that the polysilazane has a number-average molecular weight of about 150 to about 150,000 g/mol, and R¹, R², R³, R⁴, R⁵, and R⁶ can independently be hydrogen, or an optionally substituted alkyl, aryl, vinyl or (trialkoxysilyl)alkyl radical.

5. The method of claim 4, wherein the polysilazane has the formula:
—(SiR¹R²—NR³)ₙ—(SiR⁴R⁵—NR⁶)ₚ
where n and p are integers and are selected so that the polysilazane has a number-average molecular weight of about 150 to about 150,000 g/mol, and R¹, R², R³, R⁴, R⁵, and R⁶ can independently be hydrogen, or an optionally substituted alkyl, aryl, vinyl or (trialkoxysilyl)alkyl radical.

6. The method of claim 4, wherein the polysilazane has the formula:
—(SiR¹R²—NR³)ₙ—
where n is an integer and is selected so that the polysilazane has a number-average molecular weight of about 150 to about 150,000 g/mol, and R¹, R², R³, can independently be hydrogen, or an optionally substituted alkyl, aryl, vinyl or (trialkoxysilyl)alkyl radical.

7. The method of claim 4, wherein the polysilazane has the formula: 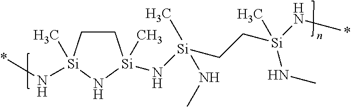
where n is an integer and is selected so that the polysilazane has a number-average molecular weight of about 150 to about 150,000 g/mol.

8. The method of claim 1, wherein the resin comprises a polycarbosilane having the formula:
—(SiR¹R²—CH₂)ₙ—
where n is an integer and is selected so that the polysilazane has a number-average molecular weight of about 150 to about 150,000 g/mol, and R¹ and R² can independently be hydrogen, or an optionally substituted alkyl, aryl, vinyl or (trialkoxysilyl)alkyl radical.

9. The method of claim 1, wherein curing the infiltrated fiber material comprises crosslinking the polymer.

10. The method of claim 1, wherein curing the infiltrated fiber material comprises contacting the pre-ceramic resin with an initiator.

11. The method of claim 1, wherein the fiber reinforced thermoset plastic composite is substantially ceramic free.

12. The method of claim 1, wherein the pre-ceramic resin has a viscosity of at least about 200 centipoise at 25° C.

13. The method of claim 1, wherein the pre-ceramic resin has a viscosity of at least about 300 centipoise at 25° C.

14. The method of claim 1, wherein the pre-ceramic resin has a viscosity of at least about 350 centipoise at 25° C.

15. The method of claim 1, wherein the pre-ceramic resin has a viscosity of from about 200 centipoise to about 450 centipoise at 25° C.

16. The method of claim 15, wherein the pre-ceramic resin has a viscosity of at least about 400 centipoise at 25° C.

17. A fiber reinforced thermoset plastic composite, comprising a pre-ceramic resin infiltrated fiber material, wherein the pre-ceramic resin is crosslinkable and comprises a polysilazane, a polycarbosilane, or a combination thereof, with a viscosity greater than about 200 centipoise (cps) at 25° C.

18. The fiber reinforced thermoset plastic composite of claim 17, wherein the polysilazane is of the formula:
—(SiR¹R²—NR³)ₙ—(SiR⁴R⁵—NR⁶)ₚ—(SiR⁷R⁸—NR⁹)_{q}—
where n, p, and q are integers and are selected so that the polysilazane has a number-average molecular weight of about 150 to about 150,000 g/mol, and R¹, R², R³, R⁴, R⁵, and R⁶ can independently be hydrogen, or an optionally substituted alkyl, aryl, vinyl or (trialkoxysilyl)alkyl radical.

19. The fiber reinforced thermoset plastic composite of claim 18, wherein the polysilazane is of the formula:
—(SiR¹R²—NR³)ₙ—(SiR⁴R⁵—NR⁶)ₚ
where n and p are integers and are selected so that the polysilazane has a number-average molecular weight of about 150 to about 150,000 g/mol, and R¹, R², R³, R⁴, R⁵, and R⁶ can independently be hydrogen, or an optionally substituted alkyl, aryl, vinyl or (trialkoxysilyl)alkyl radical.

20. The fiber reinforced thermoset plastic composite of claim 19, wherein the polysilazane is of the formula:
—(SiR¹R²—NR³)ₙ—
where n is an integer and is selected so that the polysilazane has a number-average molecular weight of about 150 to about 150,000 g/mol, and R¹, R², R³, can independently be hydrogen, or an optionally substituted alkyl, aryl, vinyl or (trialkoxysilyl)alkyl radical.

21. The fiber reinforced thermoset plastic composite of claim 19, wherein the polysilazane is of the formula: 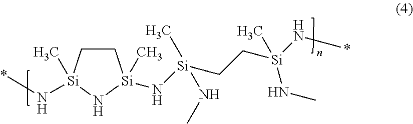
where n is an integer and is selected so that the polysilazane has a number-average molecular weight of about 150 to about 150,000 g/mol.

22. The fiber reinforced thermoset plastic composite of claim 17, wherein the polycarbosilane is of the formula:
—(SiR¹R²—CH₂)ₙ—
where n is an integer and is selected so that the polysilazane has a number-average molecular weight of about 150 to about 150,000 g/mol, and R¹ and R² can independently be hydrogen, or an optionally substituted alkyl, aryl, vinyl or (trialkoxysilyl)alkyl radical.

23. The fiber reinforced thermoset plastic composite of claim 17, wherein the pre-ceramic resin further comprises at least one of nano-particles, polysiloxane, polysilsesquioxane, solvents, melamine, urea, phenol, resorcinol, phenol-formaldehyde resin, resorcinolinic resin, epoxies, epoxy vinyl ester, epoxide, polybenzoxaines, amines, and nanoreinforcements.

24. The fiber reinforced thermoset plastic composite of claim 0, wherein the pre-ceramic resin has a viscosity greater than about 250 cps at 25° C.

25. The fiber reinforced thermoset plastic composite of claim 17, wherein the pre-ceramic resin has a viscosity greater than about 300 cps at 25° C.

26. The fiber reinforced thermoset plastic composite of claim 17, wherein the pre-ceramic resin has a viscosity greater than about 350 cps at 25° C.

27. The fiber reinforced thermoset plastic composite of claim 17, wherein the pre-ceramic resin has a viscosity greater than about 400 cps at 25° C.

28. The fiber reinforced thermoset plastic composite of claim 17, wherein the pre-ceramic resin has a viscosity greater than about 450 cps at 25° C.

29. The fiber reinforced thermoset plastic composite of claim 17, wherein the pre-ceramic resin crosslinks at a temperature less than about 300° C.

30. The fiber reinforced thermoset plastic composite of claim 17, wherein the pre-ceramic resin crosslinks at a temperature less than about 250° C.

31. The fiber reinforced thermoset plastic composite of claim 17, wherein the pre-ceramic resin crosslinks at a temperature less than about 200° C.

32. The fiber reinforced thermoset plastic composite of claim 17, wherein the pre-ceramic resin crosslinks at a temperature less than about 150° C.

33. The fiber reinforced thermoset plastic composite of claim 0, wherein the pre-ceramic resin crosslinks at a temperature less than about 100° C.

34. The fiber reinforced thermoset plastic composite of claim 17, wherein the pre-ceramic resin crosslinks at a temperature less than about 50° C.

35. The fiber reinforced thermoset plastic composite of claim 17, wherein the pre-ceramic resin further comprises an effective amount of crosslink initiator.

36. The fiber reinforced thermoset plastic composite of claim 35, wherein the crosslink initiator comprises a free-radical polymerization initiator photo-initiator or a combination thereof.

37. The fiber reinforced thermoset plastic composite of claim 36, wherein the free-radical polymerization comprises an azo compound, a peroxide, or a combination thereof.

38. The fiber reinforced thermoset plastic composite of claim 17, wherein the polymer is crosslinked to form a rigid composite.

39. The fiber reinforced thermoset plastic composite of claim 38, wherein the fiber reinforced thermoset plastic composite has a glass transition temperature greater than about 500° C.

40. The fiber reinforced thermoset plastic composite of claim 39, wherein the fiber reinforced thermoset plastic composite has a glass transition temperature greater than about 550° C.

41. The fiber reinforced thermoset plastic composite of claim 39, wherein the fiber reinforced thermoset plastic composite has a glass transition temperature greater than about 600° C.

42. The fiber reinforced thermoset plastic composite of claim 39, wherein the fiber reinforced thermoset plastic composite has a glass transition temperature greater than about 650° C.

43. The fiber reinforced thermoset plastic composite of claim 39, wherein the fiber reinforced thermoset plastic composite has a glass transition temperature greater than about 700° C.

44. The fiber reinforced thermoset plastic composite of claim 39, wherein the fiber reinforced thermoset plastic composite has a tensile strength greater than about 60,000 pounds per square inch at 25° C.

45. The fiber reinforced thermoset plastic composite of claim 39, wherein the fiber reinforced thermoset plastic composite is fracture resistant at a pressure stress of greater than about 18,000 bar at 23° C.

46. The fiber reinforced thermoset plastic composite of claim 39, wherein the fiber reinforced thermoset plastic composite is fracture resistant at a pressure stress greater than about 8,500 bar at 450° C.

47. The fiber reinforced thermoset plastic composite of claim 17, wherein the fiber material comprises continuous fiber, discontinuous fiber, or a combination thereof.

48. The fiber reinforced thermoset plastic composite of claim 47, wherein the fiber material comprises a braided or knitted preform.

49. The fiber reinforced thermoset plastic composite of claim 17, wherein the fiber material comprises a felt mat.

50. The fiber reinforced thermoset plastic composite of claim 17, wherein the fiber material comprises woven fabric.

51. The fiber reinforced thermoset plastic composite of claim 50, wherein the woven fabric is a woven fabric is a unidirectional woven fabric.

52. The fiber reinforced thermoset plastic composite of claim 50, wherein the woven fabric is a woven fabric is a bidirectional woven fabric.

53. The fiber reinforced thermoset plastic composite of claim 17, wherein the fiber material comprises a unidirectional sheet.

54. The fiber reinforced thermoset plastic composite of claim 17, wherein the fiber material comprises continuous filament fibers.

55. The fiber reinforced thermoset plastic composite of claim 1, wherein the fiber material comprises metal, glass, ceramic, polymer, carbon, mineral fiber, or blends thereof.

56. The fiber reinforced thermoset plastic composite of claim 55, wherein the mineral fiber comprises basalt fiber.

57. The fiber reinforced thermoset plastic composite of claim 17, wherein the material comprises a plurality of layers.

58. A shaped article comprising the fiber reinforced thermoset plastic composite of claim 17.

59. An element of an aircraft comprising the shaped article of claim 58.

60. An element of a spacecraft comprising the shaped article of claim 58.

61. An element of a motor vehicle engine comprising the shaped article of claim 58.

62. An aero engine having an engine core and a housing for the core, wherein the housing includes the element of an aircraft of claim 59.

63. A method for making a non-ceramic fiber reinforced thermoset plastic composite, with a glass transition temperature greater than about 500° C. comprising:
infiltrating a fiber material with a pre-ceramic resin having a viscosity greater than about 200 centipoise (cps) at about 25° C., and wherein the pre-ceramic resin comprises polysilazane, polycarbosilane, or a combination thereof; and
crosslinking the polymer by introducing crosslinks into the polymer in the absence of pyrolysis, thereby making a non-ceramic fiber reinforced thermoset plastic composite with a glass transition temperature greater than about 500° C.

64. The method of claim 63, wherein the pre-ceramic has a viscosity greater than about 300 cps at about 25° C.

65. The method of claim 63, wherein the pre-ceramic has a viscosity greater than about 350 cps at about 25° C.

66. The method of claim 63, wherein the pre-ceramic has a viscosity greater than about 400 cps at about 25° C.

67. The method of claim 63, wherein the pre-ceramic has a viscosity greater than about 450 cps at about 25° C.

68. The method of claim 63, further comprising removing the excess pre-ceramic from the fiber material.

69. The method of claim 63, wherein the fiber material comprises continuous fiber, discontinuous fiber, or a combination thereof.

70. The method of claim 63, wherein the fiber material comprises a braided or knitted preform.

71. The method of claim 63, wherein the fiber material comprises a felt mat.

72. The method of claim 63, wherein the fiber material comprises woven fabric.

73. The method of claim 72, wherein the woven fabric is a woven fabric is a uni-directional woven fabric.

74. The method of claim 72, wherein the woven fabric is a woven fabric is a bi-directional woven fabric.

75. The method of claim 63, wherein the fiber material comprises a unidirectional sheet.

76. The method of claim 63, wherein the fiber material comprises continuous filament fibers.

77. The method of claim 63, wherein the fiber material comprises metal, glass, ceramic, polymer, carbon, mineral fiber, or blends thereof.

78. The method of claim 77, wherein the mineral fiber is basalt fiber.

79. The method of claim 63, wherein the polysilazane is of the formula:
—(SiR¹R²—NR³)ₙ—(SiR⁴R⁵—NR⁶)ₚ—(SiR⁷R⁸—NR⁹)_{q}—
where n, p, and q are integers and are selected so that the polysilazane has a number-average molecular weight of about 150 to about 150,000 g/mol, and R¹, R², R³, R⁴, R⁵, and R⁶ can independently be hydrogen, or an alkyl, aryl, vinyl or (trialkoxysilyl)alkyl radical where the alkyl, aryl, vinyl or (trialkoxysilyl)alkyl radical can be substituted.

80. The method of claim 63, wherein the polysilazane comprises the formula:
—(SiR¹R²—NR³)ₙ—(SiR⁴R⁵—NR⁶)ₚ
where n and p are integers and are selected so that the polysilazane has a number-average molecular weight of about 150 to about 150,000 g/mol, and R¹, R², R³, R⁴, R⁵, and R⁶ can independently be hydrogen, or an optionally substituted alkyl, aryl, vinyl or (trialkoxysilyl)alkyl radical.

81. The method of claim 63, wherein the polysilazane comprises the formula:
—(SiR¹R²—NR³)ₙ—
where n is an integer and is selected so that the polysilazane has a number-average molecular weight of about 150 to about 150,000 g/mol, and R¹, R², R³, can independently be hydrogen, or an optionally substituted alkyl, aryl, vinyl or (trialkoxysilyl)alkyl radical.

82. The method of claim 63, wherein the polysilazane comprises the formula: 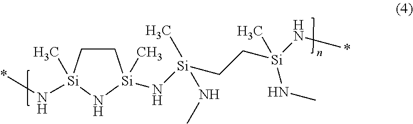
where n is an integer and is selected so that the polysilazane has a number-average molecular weight of about 150 to about 150,000 g/mol.

83. The method of claim 63, wherein the polycarbosilane comprises the formula:
—(SiR¹R²—CH₂)ₙ—
where R¹ and R², independently of one another, stand for hydrogen or an optionally substituted alkyl, alkoxy, allyl, aryl or vinyl radical, where n is selected in such a way that the polycarbosilane has a number-average molecular weight of about 150 to about 150,000 g/mol.

84. The method of claim 63, wherein the pre-ceramic resin further comprises at least one of nano-particles, polysiloxane, polysilsesquioxane, solvents, melamine, urea, phenol, resorcinol, phenol-formaldehyde resin, resorcinolinic resin, epoxide, epoxies, epoxy vinyl ester, polybenzoxaines, and nanoreinforcements.

85. The method of claim 63, wherein the fiber reinforced thermoset plastic composite is crosslinked at a temperature in the range from about 50° C. to about 300° C.

86. The method of claim 63, wherein the fiber reinforced thermoset plastic composite is crosslinked at a pressure in the range from about 0.1 bar to about 10 bar.

87. The method of claim 63, wherein the crosslinking time is from about 30 minutes to about 20 hours.

88. The method of claim 63, wherein the crosslinking is carried out in air.

89. The method of claim 63, wherein the polymer is crosslinked with the application of electromagnetic radiation.

90. The method of claim 63, wherein the polymer is crosslinked with an effective amount of crosslink initiator.

91. The method of claim of claim 90, wherein the crosslink initiator comprises a free-radical polymerization initiator, photo-initiator or a combination thereof.

92. The method of claim 91, wherein the free-radical polymerization initiator comprises an azo compound, a peroxide, or a combination thereof.

93. The method of claim 63, wherein the fiber material comprises a plurality of layers.

94. The method of claim 63, wherein the plurality of layers are laminated together before crosslinking.

95. A fiber reinforced thermoset plastic composite produced by the method of claim 63.

96. The fiber reinforced thermoset plastic composite of claim 95, wherein the fiber reinforced thermoset plastic composite has a tensile strength greater than about 60,000 pounds per square inch at 25° C.

97. The fiber reinforced thermoset plastic composite of claim 95, wherein the fiber reinforced thermoset plastic composite is fracture resistant at a pressure stress of greater than about 18,000 bar at 23° C.

98. The fiber reinforced thermoset plastic composite of claim 95, wherein the fiber reinforced thermoset plastic composite is fracture resistant at a pressure stress greater than about 8,500 bar at 450° C.
